(19) United States
(12) Patent Application Publication
(10) Pub. No.: US 2011/0304636 A1
(43) Pub. Date: Dec. 15, 2011

(54) WALLPAPER IMAGE GENERATION METHOD AND PORTABLE ELECTRIC DEVICE THEREOF

(75) Inventors: CHIEH-CHIH TSAI, TAIPEI (TW); YU-MAO FENG, TAIPEI (TW)

(73) Assignee: ACER INCORPORATED, TAIPEI COUNTY (TW)

(21) Appl. No.: 12/814,501

(22) Filed: Jun. 14, 2010

(51) Int. Cl. G06T 1/00; G06K 9/00

(52) U.S. Cl. 345/522; 382/162

(57) ABSTRACT

The present invention discloses a wallpaper image generation method and a portable electric device thereof. The portable electric device comprises an image capture module, an image analysis module, a data processing module and a display module. The image capture module is operable to capture a digital image. The image analysis module is operable to analyze the digital image to obtain a first color data. The data processing module is operable to execute an operating system and generate a wallpaper image for an operation interface of the operating system. The display module is operable to display the operation interface and the wallpaper image. In embodiment, the image analysis module randomly selects a pixel of which color is set as the first color data, and the data processing module generates the wallpaper image according to the first color data, other similar color and a predefined pattern.

### TECHNICAL FIELD

The present invention relates generally to wallpaper image generation scheme, more particularly, related to a method of generating wallpaper image for operation interface according to the captured image.

### BACKGROUND

Currently, most electric devices capable of executing operating system allow user to change the wallpaper image of the operation interface of operating system, so as the user can personalize the electric device. Traditionally, the user can change the wallpaper image by captured picture or the stored image. However, while user desires to frequently change the wallpaper image, such traditional wallpaper image change scheme is too complicate.

### SUMMARY OF THE INVENTION

Therefore, an object of the present invention is to provide a wallpaper image generation method and portable electric device thereof, in order to simplify the work flow of generating wallpaper image and increase the delight thereof.

The object of the present invention can be achieved by providing a portable electric device comprising an image capture module, an image analysis module, a data processing module and a display module. The image capture module is operable to capture a digital image. The image analysis module is operable to analyze the digital image to obtain a first color data. The data processing module is operable to execute an operating system and generate a wallpaper image for an operation interface of the operating system. The display module is operable to display the operation interface and the wallpaper image.

Preferably, the image analysis module randomly determines a selected pixel from the digital image, and set the color of the selected pixel as the first color data.

Preferably, the image analysis module randomly determines a selected area from the digital image, and generates the first color data by calculating the colors of multiple pixels of the selected area.

Preferably, the data processing module determines at least one second color data according to the first color data, and generates the wallpaper by setting the first color data and the at least one second color data to a predefined pattern.

Preferably, the operation interface comprises a view finder interface which includes a marked area for obtaining the first color data.

Preferably, the first color and the at least one second color data are harmony colors.

The object of the present invention can be achieved by providing a wallpaper image generation method comprising steps of: executing an operating system; capturing a digital image; obtaining a first color data from the digital image; generating a wallpaper image for an operation interface of the operating system according to the first data; displaying the operation interface and the wallpaper image.

Preferably, the step of obtaining the first color data further comprises steps of: randomly determining a selected pixel from the digital image; setting the color of the selected pixel as the first color data.

Preferably, the step of obtaining the first color data further comprises steps of: randomly determining a selected area from the digital image; generating the first color data by calculating the colors of multiple pixels of the selected area.

Preferably, the step of generating the wallpaper image comprises steps of: determining at least one second color data according to the first color data; generating the wallpaper by setting the first color data and the at least one second color data to a predefined pattern.

Preferably, the operation interface comprises a view finder interface which includes a marked area for obtaining the first color data.

Preferably, the first color and the at least one second color data are harmony colors.

### BRIEF DESCRIPTION OF THE DRAWINGS

The accompanying drawings, which are included to provide a further understanding of the invention, illustrate embodiments of the invention and together with the description serve to explain the principle of the invention.

FIG. 1 illustrates a block diagram of an embodiment of the portable electric device in accordance with the present invention;

FIG. 2 illustrates a schematic view of exemplary operation interface of the portable electric device in accordance with the present invention;

FIG. 3 illustrates a schematic view of first exemplary wallpaper image of the portable electric device in accordance with the present invention;

FIG. 4 illustrates a schematic view of second exemplary wallpaper image of the portable electric device in accordance with the present invention;

FIG. 5 illustrates a flow chart of the wallpaper image generation method in accordance with the present invention; and

FIG. 6 illustrates a flow chart of embodiment of the wallpaper image generation method in accordance with the present invention.

### DETAILED DESCRIPTION OF THE PREFERRED EMBODIMENTS

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

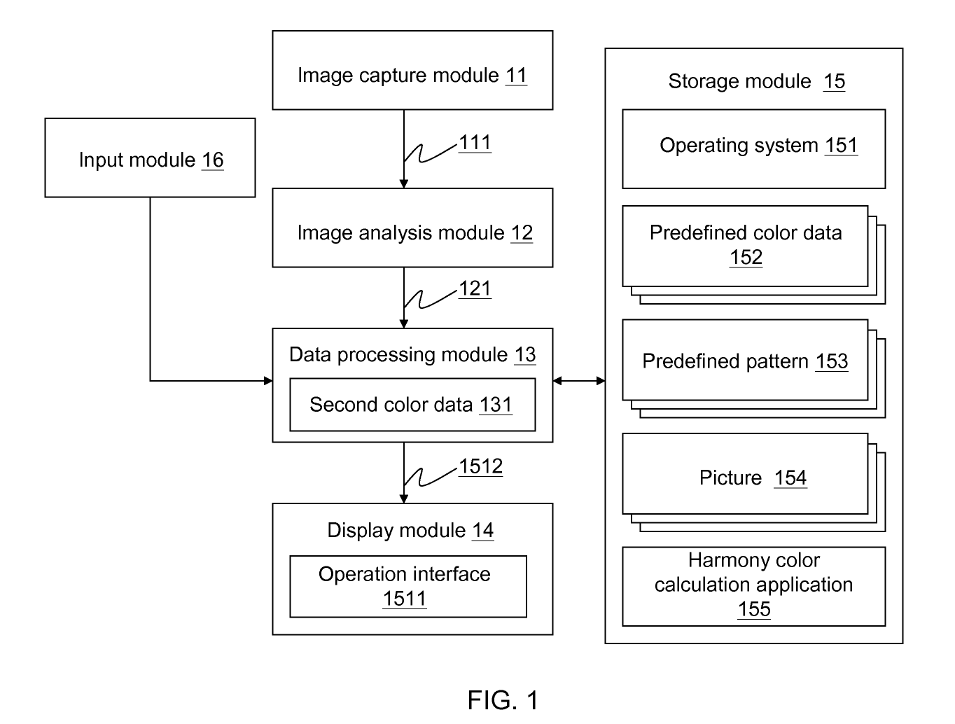

FIG. 1 illustrates a block diagram of an embodiment of the portable electric device in accordance with the present invention. The portable electric device comprises an image capture module 11, an image analysis module 12, a data processing module 13, a display module 14, a storage module 15 and an input module 16. The storage module 15 stores an operating system 151, multiple predefined color data 152, multiple predefined patterns 153, multiple pictures 154 and a harmony color calculation application 155. The data processing module 13 is operable to access the operating system 151 from the storage module 15 and execute the operating system 151 to allocate hardware and software resources of the portable electric device. While the data processing module 13 executes the operating system 151, an operation interface 1511 is generated and shown on the display module 14. Preferably, user can operate the input module 16 to set one of the pictures 154 as the wallpaper image of the operation interface 1511. Preferably, the input module 16 can comprise a touch module, arrow keys or a keypad.

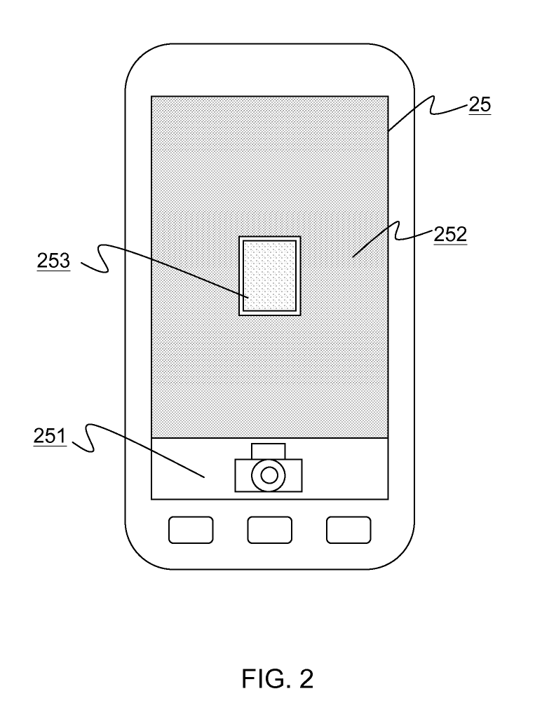

User can operate the image capture module 11 by using the input module 16, to capture a digital image 111. The image analysis module 12 then analyzes the digital image 111 to obtain a first color data 121. Please refer to FIG. 2 which illustrates a schematic view of exemplary operation interface of the portable electric device in accordance with the present invention. After user activates the image capture module, the operation interface 1511 shows a viewfinder interface 25, as shown in FIG. 2. The viewfinder interface 25 preferably comprises a shutter button 251 and an image preview area 252, so that user can preview the image corresponding to the light signal received by the image capture module 11, and user can trigger the shutter button 251 to drive the image capture module 11 to capture the digital image 111 viewed in the image preview area 252. Preferably, the viewfinder interface 25 can further comprises a marked area 253 from which the first color data 121 is obtained.

In embodiment, the image analysis module 12 can randomly determines a selected pixel from the digital image 111, such as one of pixels of the digital image 111 corresponding to the marked area 253, and set the color of the selected pixel as the first color data 121. The image analysis module 12 can also randomly determines a selected area from the digital image, for example, the portion of the digital image 111 corresponding to the marked area 253, and generates the first color data 121 by calculating the colors of multiple pixels of the selected area. For example, the first color data can be the average or median of the colors of these pixels.

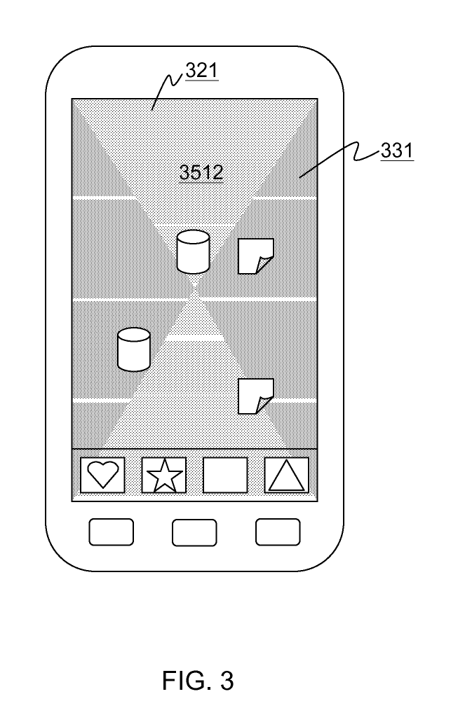

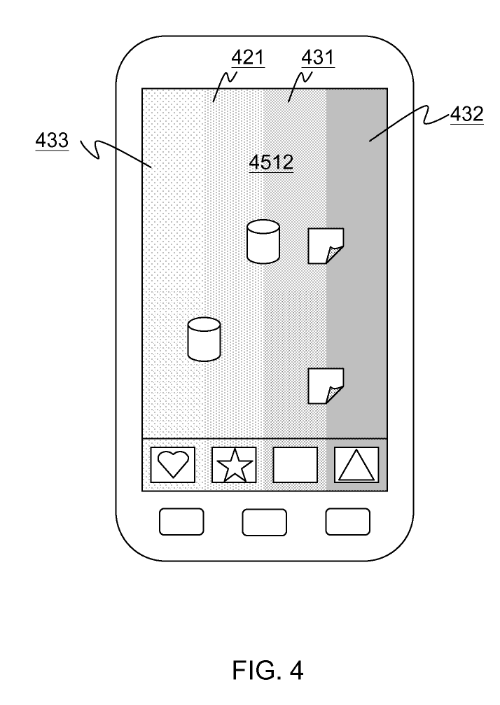

The data processing module 13 determines at least one second color data 131 according to the first color data 121. Preferably, the data processing module 13 can use the first color data 121 as an input parameter to execute the harmony color application to generate the second color data 131. Besides, the data processing module 13 can select at least one of the predefined color data 152 as the second color data. Preferably, the predefined color data 152 can form a color wheel. The data processing module 13 then generates a wallpaper image 1512 by setting the first color data 121 and at least one second color data 131 to one of the predefined pattern 153. The display module 14 is operable to display the operation interface 1511 and the wallpaper image 1512. Preferably, the first color 121 and the at least one second color 131 data are harmony colors, and the number of first color 121 or second color 131 can larger than one. Please refer to FIG. 3 and FIG. 4 which respectively illustrate first and second exemplary wallpaper image of the portable electric device in accordance with the present invention. In FIG. 3, the wallpaper 3512 is formed by an intersection pattern filled with the first color data 321 and the second color data 331. In FIG. 4, the wallpaper 4512 is formed by a column pattern filled with the first color data 421, the second color data 431, the second color data 432 and the second color data 433. According to these two examples, it can be explained that number of the second color data generated by the data processing module 13 depends on the type of pattern selected by the user. While user selects the intersection pattern shown in FIG. 3, the data processing module 13 generates one second color data according to the first color data; while user selects the column pattern shown in FIG. 4, the data processing module 13 generates three second color data according to the first color data.

Preferably, the first color data and the second color data can match the following harmony color schemes: (1) Monochromatic color scheme: the lightness or saturation of a single hue of first color data is varied to generate the second color data; (2) Analogous color scheme: the first color data and at least second color data are adjacent to each other on the color wheel; (3) Complementary color scheme: the first color data and at least second color data are opposite each other on the color wheel; (4) Split complementary color scheme: the two second color data are adjacent to complementary color of the first color data; (5) Triadic color scheme: the first color data and two second color data are equally spaced around the color wheel.

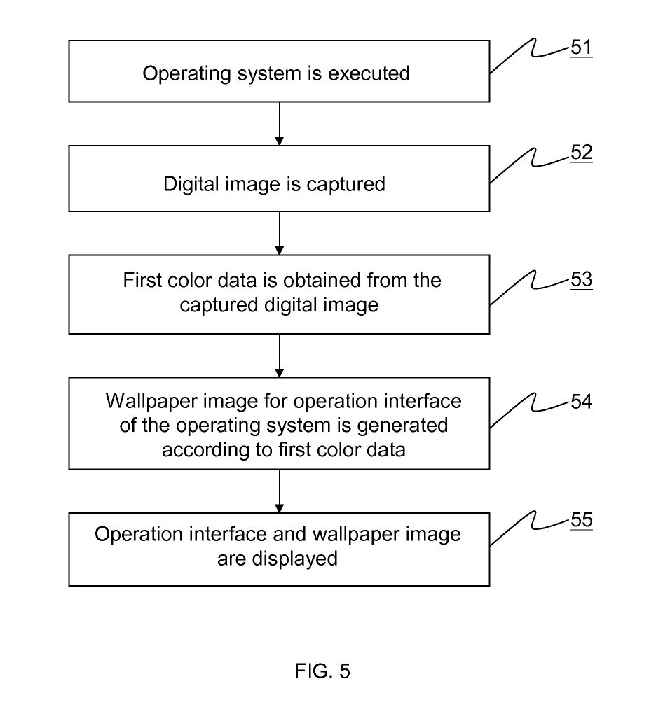

FIG. 5 illustrates a flow chart of the wallpaper image generation method in accordance with the present invention. The method comprises the following steps. In step 51, an operating system is executed. In step 52, a digital image is captured. In step 53, a first color data is obtained from the captured digital image. Preferably, the step of obtaining the first color data can be implemented by randomly determining a selected pixel from said digital image and setting the color of said selected pixel as said first color data. Preferably, the step of obtaining the first color data also can be implemented by randomly determining a selected area from said digital image and generating said first color data by calculating the colors of multiple pixels of said selected area. For example, the first color data can be the average or median of the colors of such pixels.

In step 54, a wallpaper image for the operation interface of the operating system is generated according to the first color data. Preferably, the step of generating the wallpaper image can be implemented by determining at least one second color data according to said first color data and then generating said wallpaper by setting said first color data and said at least one second color data to a predefined pattern. Preferably, the first color and the second color data can be harmony colors. In step 55, the operation interface and the wallpaper image are displayed. Preferably, the operation interface comprises a view finder interface which includes a marked area for obtaining the first color data, as shown in FIG. 2.

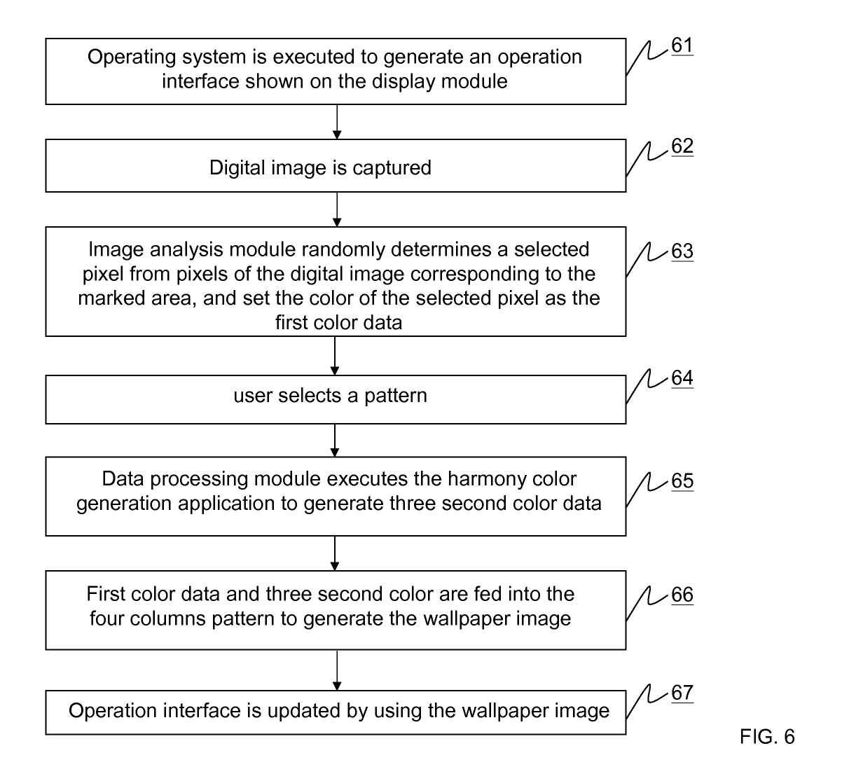

FIG. 6 illustrates a flow chart of embodiment of the wallpaper image generation method in accordance with the present invention. This embodiment applied in a portable electric device shown in FIG. 1, comprises the following steps. In step 61, the data processing module 13 executes the operating system 151 to generate an operation interface shown on the display module 14. The operation interface 1511 comprises a viewfinder interface 25 which comprises a marked area 253 from which the first color data 121 is obtained, as shown in FIG. 2. By viewing the image shown in marked area 253, user can check the possible color for wallpaper image. In step 62, user operates the image capture module 11 to capture a digital image 111. In step 63, the image analysis module 12 randomly determines a selected pixel from pixels of the digital image 111 corresponding to the marked area 253, and set the color of the selected pixel as the first color data 121. In step 64, user selects one of patterns 153, such as the four columns pattern shown in FIG. 4. In step 65, the data processing module 13 executes the harmony color generation application 155 to generate three second color data. In step 66, the first color data and three second color are fed into the four columns pattern to generate the wallpaper image 4512. In step 67, the operation interface 1511 is updated by using the wallpaper image 4512.

Thus, specific embodiments and applications of wallpaper image generation method and portable electric device thereof have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the invention. In addition, where the specification and claims refer to at least one of something selected from the group consisting of A, B, C . . . and N, the text should be interpreted as requiring only one element from the group, not A plus N, or B plus N, etc.

What is claimed is:

1. A portable electric device, comprising:
an image capture module capturing a digital image;
an image analysis module analyzing said digital image to obtain a first color data;
a data processing module executing an operating system and generating a wallpaper image for an operation interface of said operating system according to said first data; and
a display module displaying said operation interface and said wallpaper image.

2. The portable electric device of claim 1, wherein said image analysis module randomly determines a selected pixel from said digital image, and set the color of said selected pixel as said first color data.

3. The portable electric device of claim 1, wherein said image analysis module randomly determines a selected area from said digital image, and generates said first color data by calculating the colors of multiple pixels of said selected area.

4. The portable electric device of claim 1, wherein said data processing module determines at least one second color data according to said first color data, and generates said wallpaper image by setting said first color data and said at least one second color data to a predefined pattern.

5. The portable electric device of claim 1, wherein said operation interface comprises a view finder interface which includes a marked area for obtaining said first color data.

6. The portable electric device of claim 1, wherein said first color and said at least one second color data are harmony colors.

7. A wallpaper image generation method, comprising steps of:
executing an operating system;
capturing a digital image;
obtaining a first color data from said digital image;
generating a wallpaper image for an operation interface of said operating system according to said first data; and
displaying said operation interface and said wallpaper image.

8. The wallpaper image generation method of claim 7, wherein said step of obtaining said first color data further comprises steps of:
randomly determining a selected pixel from said digital image; and
setting the color of said selected pixel as said first color data.

9. The wallpaper image generation method of claim 7, wherein said step of obtaining said first color data further comprises steps of:
randomly determining a selected area from said digital image; and
generating said first color data by calculating the colors of multiple pixels of said selected area.

10. The wallpaper image generation method of claim 7, wherein said step of generating said wallpaper image comprises steps of:
determining at least one second color data according to said first color data; and
generating said wallpaper by setting said first color data and said at least one second color data to a predefined pattern.

11. The wallpaper image generation method of claim 7, wherein said operation interface comprises a view finder interface which includes a marked area for obtaining said first color data.

12. The wallpaper image generation method of claim 7, wherein said first color and said at least one second color data are harmony colors.
